(19) United States
(12) Patent Application Publication
(10) Pub. No.: US 2017/0087660 A1
(43) Pub. Date: Mar. 30, 2017

(54) ELECTRIC RESISTANCE WELDING ELECTRODE

(71) Applicants: SHOJI AOYAMA, Osaka (JP); TOYOTA JIDOSHA KABUSHIKI KAISHA, Aichi-ken (JP)

(72) Inventors: Kohei HISADA, Nagoya-shi Aichi-ken (JP); Yoshitaka AOYAMA, Sakai-shi Osaka (JP); Shoji AOYAMA, Sakai-shi Osaka (JP)

(21) Appl. No.: 15/139,489

(22) Filed: Apr. 27, 2016

(30) Foreign Application Priority Data
Sep. 24, 2015 (JP) 2015-202402

(51) Int. Cl. B23K 11/30; B23K 11/11

(52) U.S. Cl. CPC B23K 11/3009; B23K 11/11

(57) ABSTRACT

Provided is an electric resistance welding electrode, which comprises an insulated cylinder, an electrode slidably inserted into the insulated cylinder, an urging member configured to apply an advance force to the insulated cylinder, and a stopper configured to set an advance distance of an insulated end surface of the insulated cylinder with respect to an pressing surface of the electrode to a predetermined distance. A receiving recessed portion for receiving a component is defined by the pressing surface retreated by the predetermined distance with respect to the insulated end surface and an inner surface of the insulated cylinder. The electric resistance welding electrode performs welding in one of welding modes consisting of a component welding mode and a spot welding mode.

### TECHNICAL FIELD

The present invention relates to an electric resistance welding electrode, which is configured to weld a component to a steel plate, and to spot-weld a plurality of steel plates to each other.

### BACKGROUND ART

In Japanese Patent No. 3885213, there is described that, when a component is fitted into a holding cylinder, and the holding cylinder is advanced to press the component against a steel plate as a counterpart, an electrode arranged in the holding cylinder is relatively advanced with respect to the holding cylinder to press the component, and then welding current is supplied to weld the component to the steel plate.

### SUMMARY OF INVENTION

### Technical Problem

In the technology disclosed in Japanese Patent No. 3885213, a distance between the component inserted into the holding cylinder and the electrode in a standby state is large. Thus, the holding cylinder is pushed by an excessively long distance during the welding operation, thereby increasing a welding cycle necessary for welding one component. Therefore, improvement in terms of productivity is demanded. Further, in the structure disclosed in Japanese Patent No. 3885213, although the component can be welded to the steel plate, a plurality of steel plates cannot be integrated by spot welding.

The present invention has been made to solve the above-mentioned problems, and has an object to weld a component to a steel plate as a counterpart and integrate a plurality of steel plates by spot welding through use of a single electric resistance welding electrode.

### Solution to Problem

According to the present invention, there is provided an electric resistance welding electrode, comprising:

an insulated cylinder formed of an insulating material, the insulated cylinder having an insulated end surface at an end surface thereof;

an electrode formed of an elongated member having a circular cross-section, the electrode being inserted into the insulated cylinder under a state of being slidable in a direction of an electrode axis, the electrode having a pressing surface at an end surface thereof;

an urging member configured to apply an advance force to the insulated cylinder so that the insulated cylinder advances with respect to the electrode;

a stopper configured to set an advance distance of the insulated end surface of the insulated cylinder with respect to the pressing surface of the electrode to a predetermined distance,

wherein a receiving recessed portion having a predetermined depth is defined by the pressing surface of the electrode that retreats by the predetermined distance with respect to the insulated end surface of the insulated cylinder and an inner surface of the insulated cylinder, the predetermined depth of the receiving recessed portion being set such that a component to be received in the receiving recessed portion is protruded from the insulated end surface of the insulated cylinder under a state of the component being in close contact with the pressing surface of the electrode,

the electric resistance welding electrode performing welding in one of welding modes consisting of:
a component welding mode in which the component received in the receiving recessed portion is pressed against a steel plate to weld the component to the steel plate; and
a spot welding mode in which the insulated end surface of the insulated cylinder and the pressing surface of the electrode are pressed against a steal plate of a plurality of steel plates overlapped each other to weld the steel plates to each other.

### Advantageous Effects of Invention

For example, the component such as a projection nut is received in the receiving recessed portion formed by the pressing surface and the inner surface of the insulated cylinder under a state in which the component is in close contact with the pressing surface and partially protruded from the insulated end surface of the insulated cylinder. Therefore, when the electric resistance welding electrode is advanced toward the steel plate, the component is brought into contact with the steel plate and sandwiched between the pressing surface and the steel plate. After that, welding current is supplied to perform the welding. In this manner, the component is securely sandwiched between the pressing surface and the steel plate, and hence an idle operation of reducing space between the pressing surface of the electrode and the component is omitted, thereby reducing a cycle time period of the welding operation. Such reduction in cycle time period is effective to improve productivity.

The component is welded to the steel plate under the state of being partially protruded from the insulated end surface of the insulated cylinder. Thus, even after completion of the welding, a space can be secured between the insulated end surface and the steel plate. Therefore, the insulated end surface is distanced from the welded portion having the highest temperature. With this state, thermal damage to the end surface portion of the insulated cylinder can be prevented.

In order to set the depth of the receiving recessed portion to the predetermined value, the stopper and the urging member are provided. The urging member is configured to apply an advance force to the insulated cylinder so that the insulated cylinder advances with respect to the electrode. The stopper is configured to set an advance distance of the insulated end surface of the insulated cylinder with respect to the pressing surface of the electrode to a predetermined distance. Therefore, the depth of the receiving recessed portion can accurately be set, thereby being capable of securely attaining the state in which the component inserted into the receiving recessed portion is securely held in close contact with the pressing surface, and the component is partially protruded from the insulated end surface. Through such close contact, the component is brought into contact with the steel plate, and the component is securely sandwiched between the pressing surface and the steel plate at the same time. With the protrusion of the component, the thermal damage to the end surface portion of the insulated cylinder can be prevented.

In integration of the plurality of steel plates overlapped each other by spot welding, along with the advance of the electric resistance welding electrode, first, the insulated end surface of the insulated cylinder is brought into close contact with a surface of the steel plate, and then, the pressing surface is brought into close contact with the steel plate. Welding current is supplied while the insulated end surface and the pressing surface are pressed against the steel plate in this manner to perform the spot welding. Portions of the steel plates corresponding to the pressing surface are melted, but a direct heat flow to the insulated end surface is reduced. Therefore, the heating to the insulated end surface is alleviated, thereby being effective to improve durability of the insulated cylinder. Further, the insulated end surface is not directly brought into contact with the melted portion, thereby reducing a thermal effect on the insulated end surface.

As described above, the component welding mode and the spot welding mode are securely attained through use of the single electrode.

### BRIEF DESCRIPTION OF DRAWINGS

FIG. 1A is a sectional view of an electric resistance welding electrode taken along an electrode axis.

FIG. 1B is a sectional view of the electric resistance welding electrode taken along the line B-B in FIG. 1A.

FIG. 1C is a bottom view of an insulated cylinder.

FIG. 1D is an enlarged sectional view for illustrating the surrounding of a receiving recessed portion.

FIG. 2A is a sectional view for illustrating a component welding mode.

FIG. 2B is a sectional view for illustrating a spot welding mode.

FIG. 2C is a partial side view for illustrating another shape of an end surface of an electrode.

### DESCRIPTION OF EMBODIMENTS

Next, an electric resistance welding electrode according to an embodiment of the present invention is described.

### Embodiment

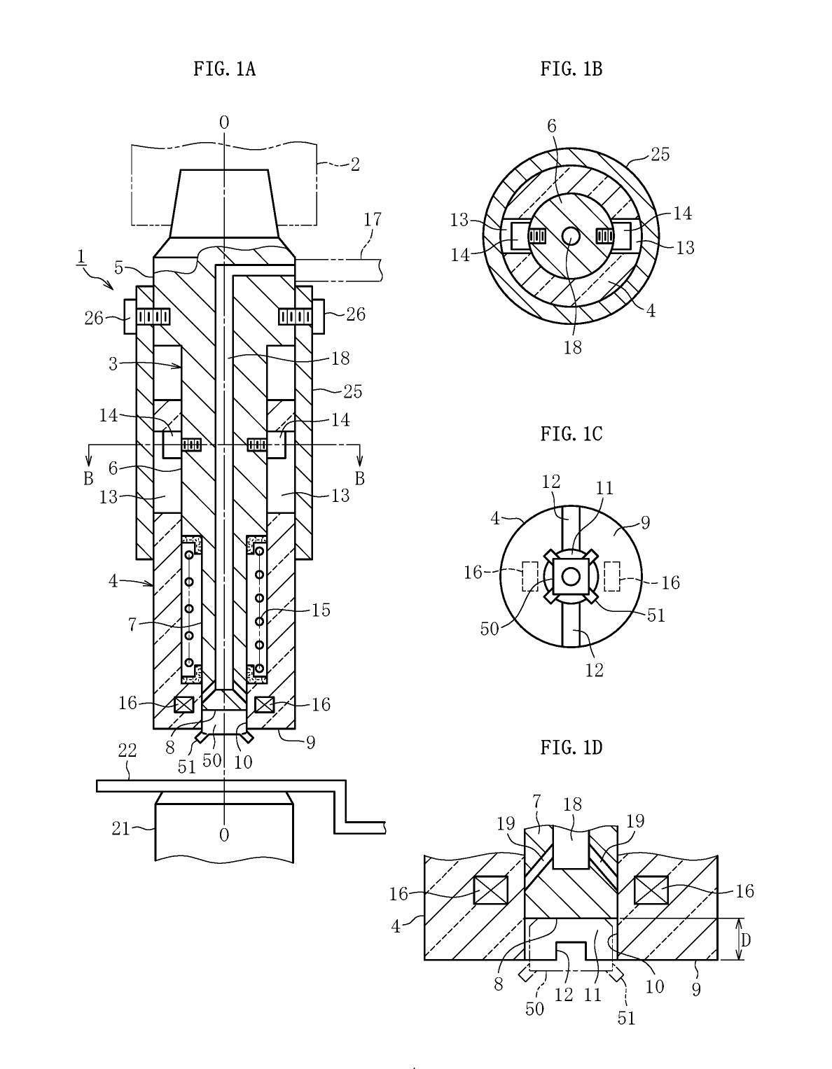

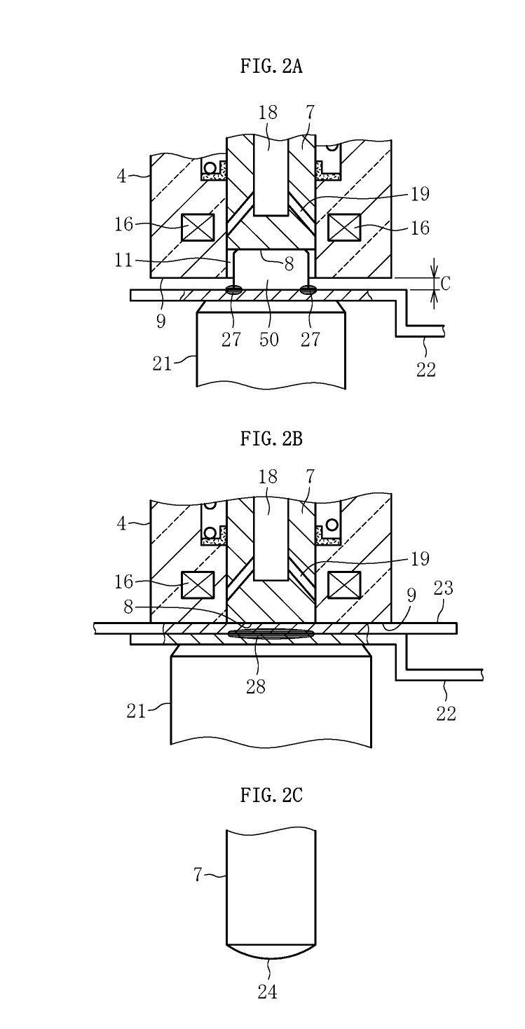

FIG. 1A to FIG. 1D and FIG. 2A to FIG. 2C are illustrations of the embodiment of the present invention.

The electric resistance welding electrode of the embodiment may be operated as a movable electrode or a fixed electrode. In this embodiment, the electric resistance welding electrode functions as the movable electrode.

First, a component is described.

As the component to be welded by the electric resistance welding electrode of the embodiment, there are given a wide variety of components, such as a projection nut and an annular washer having a welding projection. In this case, a projection nut 50 is used as the component. The projection nut 50 has a screw hole formed at the center of a square body. The projection nut 50 has a flat upper surface and a flat lower surface, and welding projections 51 are formed at four corners of the lower surface. In the following description, the projection nut may simply be referred to as the nut.

Next, the entire electric resistance welding electrode is described.

An entire electric resistance welding electrode 1 is fixed to a fixing member 2 configured to be driven to advance and retreat by an advance and retreat driver (not shown).

An electrode 3 is obtained by forming a copper alloy such as copper-chromium alloys into an elongated member having a circular cross-section. An insulated cylinder 4 is obtained by forming an insulating material such as a phenol resin into a cylindrical shape. The electrode 3 is inserted into the insulated cylinder 4 under a state of being slidable in a direction of an electrode axis O-O.

The electrode 3 has a large diameter portion 5, a medium diameter portion 6, and a small diameter portion 7. In actuality, the medium diameter portion 6 and the small diameter portion 7 are inserted into the insulated cylinder 4. Therefore, a main configuration of the electric resistance welding electrode 1 resides in that the electrode 3 is inserted into the insulated cylinder 4.

Next, a receiving recessed portion is described.

A pressing surface 8 is formed on an end surface of the small diameter portion 7 of the electrode 3, and an insulated end surface 9 is formed on an end surface of the insulated cylinder 4. The pressing surface 8 is located at a position retreated with respect to the insulated end surface 9. With such a positional relationship, a receiving recessed portion 11 is formed by the pressing surface 8 and an inner surface 10 of the insulated cylinder 4.

A depth D of the receiving recessed portion 11 is defined in the direction of the electrode axis O-O, and is set as a distance between the pressing surface 8 and the insulated end surface 9. The depth D is set to such a value that the nut 50 is protruded from the insulated end surface 9 at a side of the welding projections 51 under a state in which an upper surface of the nut 51 is in close contact with the pressing surface 8.

In other words, the positional relationship is set so that the insulated cylinder 4 is protruded or advanced with respect to the electrode 3, and a stopper is provided so as to set such a positional relationship. The stopper is configured to set a maximum protruding amount or advance distance of the insulated cylinder 4 with respect to the electrode 3. As a structural example for the stopper, there may be employed various types of structure, such as the structure that a protruding member of the electrode is fitted into a guide hole formed in the insulated cylinder 4, or the structure that a protruding member formed on the insulated cylinder 4 is fitted into a guide hole formed in a protective cylinder described later. In this embodiment, the former structure is employed.

That is, protruding members 14 formed on the medium diameter portion 6 are inserted into guide holes 13 of elongated holes formed in the insulated cylinder 4 in the direction of the electrode axis O-O. The protruding members 14 are head portions of bolts screwed into the medium diameter portion 6. A compression coil spring 15 as an urging member is inserted between an inner end surface of the insulated cylinder 4 and a boundary portion between the medium diameter portion 6 and the small diameter portion 7. Due to tension of the compression coil spring 15, upper end portions of the guide holes 13 are pressed against the protruding members 14. With this, the depth D of the receiving recessed portion 11 is set. As the function of the urging member, a pushing force by compressed air may be employed instead of the compression coil spring 15.

As is apparent from the above description, the stopper comprises the guide holes 13, the protruding members 14, and the compression coil spring 15.

FIG. 1B is a sectional view taken along the line B-B in FIG. 1A, and FIG. 1C is a bottom view of the insulated cylinder 4. Further, FIG. 1D is an enlarged view of the surrounding of the receiving recessed portion 11.

Permanent magnets 16 are embedded in the vicinity of a distal end of the insulated cylinder 4 so that the nut 50 inserted into the receiving recessed portion 11 is held in the receiving recessed portion 11. The permanent magnets 16 are fixed at positions shifted obliquely upward from the receiving recessed portion 11 so that the upper surface of the nut 50 is held in close contact with the pressing surface 8 of the electrode 3. With this, an attraction force in an upward direction along the electrode axis O-O is applied to the nut 50.

Next, an air cooling structure is described.

An air passage 18 to which a supply hose 17 is connected is formed at the center portion of the electrode 3. Air jet passages 19 extending obliquely are connected to a distal end portion of the air passage 18, and are opened to an outer peripheral surface of the small diameter portion 7 in the vicinity of the pressing surface 8. As described later, when the electric resistance welding electrode 1 is pressed and supplied with current, compressed air is supplied from the supply hose 17, and is jetted from each air jet passage 19.

Through exhaust grooves 12 formed in the insulated end surface 9 in a diameter direction, the receiving recessed portion 11 communicates to an outer peripheral side of the insulated cylinder 4. The jetted air passes through a sliding gap of the small diameter portion 7 to be blown out into the receiving recessed portion 11, to thereby cool a welded portion and the distal end portion of the insulated cylinder 4. At least two air jet passages 19 are formed obliquely. Thus, the air flows through the sliding gap of the small diameter portion 7 smoothly, thereby cooling a wide range.

Next, the other structure is described.

A fixed electrode 21 paired with the electric resistance welding electrode 1 is provided, and steel plate is placed on the fixed electrode 21. When the nut 50 is welded to the steel plate, a piece of steel plate 22 is placed on the fixed electrode 21. On the other hand, when another steel plate 23 is welded to the steel plate 22 by spot welding, the another steel plate 23 is overlapped on the steel plate 22. Three or more of steel plates may be overlapped each other and placed on the fixed electrode 21.

The end surface of the small diameter portion 7 is formed as the pressing surface 8 being a flat surface, however, the pressing surface 8 may be formed as a spherical surface 24 as illustrated in FIG. 2C.

A protective cylinder 25 formed of a cylindrical member made of stainless steel is fixed to the large diameter portion 5 by fixing bolts 26. The protective cylinder 25 is extended to a portion below the guide holes 13 so as to prevent entry of impurities such as iron scraps or spatters into the guide holes 13. The insulated cylinder 4 is slidably inserted into the protective cylinder 25.

When the pressing surface 8 is pressed many times against the nut 50 and the steel plate 23, the pressing surface 8 may be worn or damaged. In view of this, it is desired that a replacement chip for the pressing surface 8 be detachably mounted to a distal end of the small diameter portion 7 with, for example, screw structure.

Next, welding modes are described.

FIG. 2A is an illustration of a “component welding mode” for welding the nut 50 to the steel plate 22. The nut 50 inserted into the receiving recessed portion 11 is attracted by the permanent magnets 16, so that the upper surface of the nut 50 is brought into close contact with the pressing surface 8, and the nut 50 is protruded from the insulated end surface 9 at the side of the welding projections 51. When the electric resistance welding electrode 1 is moved downward under such a state, the welding projections 51 are pressed against the steel plate 22 without changing a relative position between the electrode 3 and the insulated cylinder 4. That is, the pressing surface 8 is held in close contact with the upper surface of the nut 50, and hence the nut 50 is firmly sandwiched between the pressing surface 8 and the steel plate 22 at the same time when the welding projections 51 reach the steel plate 22. The nut 50 may be supplied to the receiving recessed portion 11 by an operator manually, a supply rod of a component supply device, or other measures.

When welding current is supplied under such a sandwiched state, the welding projections 51 and the steel plate 22 are melted, and portions corresponding to the welding projections 51 are welded to the steel plate 22. Ata time before or after the welding, cooling air is jetted from each air jet passage 19. Then, after completion of the welding, an air gap C is secured between the insulated end surface 9 and the steel plate 22. A protrusion length of the nut 50 on the side of the welding projections 51 when the nut 50 is inserted into the receiving recessed portion 11 is set in advance so that such an air gap C can be secured. The height of the welding projections 51 is eliminated after the melting, and hence such a protrusion length is set so that the main body of the nut 30 is partially protruded from the insulated end surface 9. In this manner, the air gap C is secured. The welded portions are colored black, and are each denoted by the reference symbol 27.

The cooling air jetted from each air j et passage 19 passes through a sliding gap of the small diameter portion 7, blown out into the receiving recessed portion 11, and is discharged to the outside through the air gap C and the exhaust grooves 12. Owing to such a flow of the cooling air, the welded portions 27 are air-cooled, and spatters and the like are discharged to the outside through the exhaust grooves 12.

After completion of the above-mentioned component welding mode, the nut welding is continuously performed, or a spot welding mode described later is performed.

FIG. 2B is an illustration of a “spot welding mode” for welding another steel plate 23 to the steel plate 22 by spot welding. When the electric resistance welding electrode 1 is moved downward under a state in which the nut 50 is not inserted into the receiving recessed portion 11, the insulated end surface 9 is pressed against a surface of the steel plate 23 without changing the relative position between the electrode 3 and the insulated cylinder 4. From this point, as the electric resistance welding electrode 1 is further moved downward, the pressing surface 8 is brought closer to the surface of the steel plate 23 while the electrode 3 compresses the compression coil spring 15, thereby reducing space of the receiving recessed portion 11. After that, the pressing surface 8 is also pressed against the steel plate 23, and then, the welding current is supplied. Thereby, a close-contact portion between the steel plate 23 and the steel plate 22 is melted to be welded to each other. At a time before or after the welding, the cooling air is jetted from each air jet passage 19. The welded portion is colored black, and is denoted by the reference symbol 28.

The cooling air jetted from each air j et passage 19 passes through the sliding gap of the small diameter portion 7, blown out into the receiving recessed portion 11, and is discharged from the exhaust grooves 12. When the small diameter portion 7 is further advanced to eliminate the space of the receiving recessed portion 11, the pressing surface 8 and the insulated end surface 9 are brought into close contact with the steel plate 23, and the cooling air is discharged through the exhaust grooves 12. In this flow of the cooling air, the welded portion 28 is air-cooled, and spatters and the like are discharged to the outside through the exhaust grooves 12.

After completion of the above-mentioned spot welding mode, the spot welding is continuously performed, or the above-mentioned nut welding mode are performed.

Functions and effects of the embodiment described above are as follows.

The projection nut 50 is received in the receiving recessed portion 11 formed by the pressing surface 8 and the inner surface 10 of the insulated cylinder under the state in which the upper surface of the nut 50 is held in close contact with the pressing surface 8 and the nut 50 is partially protruded from the insulated end surface 9 of the insulated cylinder 4 at the side of the welding projections 51. Therefore, when the electric resistance welding electrode 1 is advanced toward the steel plate 22, the nut 50 is brought into contact with the steel plate 22 and at the same time is sandwiched between the pressing surface 8 and the steel plate 22. After that, the welding current is supplied to perform the welding. In this manner, the nut 50 is securely sandwiched between the pressing surface 8 and the steel plate 22, and hence an idle operation of reducing space between the electrode pressing surface 8 and the nut 50 is omitted, thereby reducing a cycle time period of the welding operation. Such reduction in cycle time period is effective to improve productivity.

The nut 50 is welded to the steel plate 22 under the state of being partially protruded from the insulated end surface 9 of the insulated cylinder 4. Thus, even after the completion of the welding, the air gap C can be secured between the insulated end surface 9 and the steel plate 22. Therefore, the insulated end surface 9 is distanced from the welded portions 27 each having the highest temperature. With this state, thermal damage to the end surface portion of the insulated cylinder 4 can be prevented.

In order to set the depth D of the receiving recessed portion 11 to a predetermined value, the stopper and the compression coil spring (urging member) 15 are provided. The stopper is configured to set an advance distance of the insulated cylinder 4 with respect to the pressing surface 8 to the predetermined distance D, and the compression coil spring 15 is configured to apply an advance force to the insulated cylinder 4. Therefore, the depth D of the receiving recessed portion 11 can accurately be set, thereby being capable of securely attaining the state in which the nut 50 inserted into the receiving recessed portion 11 is securely held in close contact with the pressing surface 8, and the nut 50 is partially protruded from the insulated end surface 9. Through such close contact, the nut 50 is brought into contact with the steel plate, and at the same time the nut 50 is securely sandwiched between the pressing surface 8 and the steel plate 8. With the protrusion of the nut, the thermal damage to the end surface portion of the insulated cylinder 4 can be prevented.

In integration of the plurality of steel plates 22, 23 overlapped each other by spot welding, along with the advance of the electric resistance welding electrode 1, first, the insulated end surface 9 of the insulated cylinder 4 is brought into close contact with a surface of the steel plate 23, and then, the pressing surface 8 is brought into close contact with the steel plate 23. Welding current is supplied while the insulated end surface 9 and the pressing surface 8 are pressed against the steel plate 23 in this manner to perform the spot welding. Portions of the steel plates 22 and 23 corresponding to the pressing surface 8 are melted, but a direct heat flow to the insulated end surface 9 is reduced. Therefore, the heating to the insulated end surface 9 is alleviated, thereby being effective to improve durability of the insulated cylinder 4. Further, the insulated end surface 9 is not directly brought into contact with the melted portion 28, thereby reducing a thermal effect on the insulated end surface 9.

As described above, the component welding mode and the spot welding mode are securely attained through use of the single electrode.

The air jet passages 19 obliquely branched from the air passage 18 are opened to the outer peripheral surface of the small diameter portion 7 in the vicinity of the pressing surface 8. With this, the jetted air forcefully passes through the sliding gap of the small diameter portion 7, and is blown out onto the welded portions 27, thereby being capable of reducing transmission and diffusion of metal melting heat. Similarly, in the case of the melted portion 28, the air is blown out from the sliding gap of the small diameter portion 7 onto an outer peripheral portion of the melted portion 28, thereby being capable of reducing the transmission and the diffusion of the metal melting heat.

The protruding members 14 fixed to the electrode 3 are inserted into the guide holes 13 formed in the insulated cylinder 4, and the protective cylinder 25 covers the guide holes 13. Therefore, the guide holes 13 are completely closed. With this state, the entry of impurities such as iron scraps or spatters into the sliding portion can be prevented.

Further, the compression coil spring 15 is arranged between the inner end surface of the insulated cylinder 4 and a step portion at the boundary portion between the medium diameter portion 6 and the small diameter portion 7. Moreover, the protruding members 14 fixed to the electrode 3 are inserted into the guide holes 13 formed in the insulated cylinder 4. With this structure, the stopper is constituted in the insertion structure of the electrode 3 and the insulated cylinder 4, thereby securely setting the depth D of the receiving recessed portion 11. At the same time, the structure of the electric resistance welding electrode 1 is simplified, and also reduced in dimension.

### INDUSTRIAL APPLICABILITY

As described above, according to the electric resistance welding electrode of the present invention, it is possible to weld a component to the steel plate as a counterpart and integrate a plurality of steel plates by spot welding with the single electric resistance welding electrode. Therefore, the electric resistance welding electrode of the present invention may be used in a wide variety of industrial fields, specifically, in a vehicle body welding process for automobiles, and a sheet metal welding process for home electrical appliances.

1. An electric resistance welding electrode, comprising:
an insulated cylinder formed of an insulating material, the insulated cylinder having an insulated end surface at an end surface thereof;
an electrode formed of an elongated member having a circular cross-section, the electrode being inserted into the insulated cylinder under a state of being slidable in a direction of an electrode axis, the electrode having a pressing surface at an end surface thereof;
an urging member configured to apply an advance force to the insulated cylinder so that the insulated cylinder advances with respect to the electrode;
a stopper configured to set an advance distance of the insulated end surface of the insulated cylinder with respect to the pressing surface of the electrode to a predetermined distance,
wherein a receiving recessed portion having a predetermined depth is defined by the pressing surface of the electrode that retreats by the predetermined distance with respect to the insulated end surface of the insulated cylinder and an inner surface of the insulated cylinder, the predetermined depth of the receiving recessed portion being set such that a component to be received in the receiving recessed portion is protruded from the insulated end surface of the insulated cylinder under a state of the component being in close contact with the pressing surface of the electrode,
the electric resistance welding electrode performing welding in one of welding modes consisting of:
a component welding mode in which the component received in the receiving recessed portion is pressed against a steel plate to weld the component to the steel plate; and
a spot welding mode in which the insulated end surface of the insulated cylinder and the pressing surface of the electrode are pressed against a steal plate of a plurality of steel plates overlapped each other to weld the steel plates to each other.
